(19) United States
(12) Patent Application Publication
(10) Pub. No.: US 2013/0059553 A1
(43) Pub. Date: Mar. 7, 2013

(54) ANTENNA APPARATUS, ANTENNA SYSTEM, AND METHOD OF ADJUSTING ANTENNA APPARATUS

(71) Applicants: Naoyuki Orihashi, Tokyo (JP); Kenichi Maruhashi, Tokyo (JP)

(72) Inventors: Naoyuki Orihashi, Tokyo (JP); Kenichi Maruhashi, Tokyo (JP)

(73) Assignee: NEC CORPORATION, Minato-ku, Tokyo (JP)

(21) Appl. No.: 13/697,044

(22) PCT Filed: Apr. 11, 2011
(86) PCT No.: PCT/JP2011/002121

§ 371 Date: Nov. 9, 2012

(30) Foreign Application Priority Data
May 21, 2010 (JP) 2010-117305

(51) Int. Cl. H01Q 21/24; H04B 1/04; H01Q 3/24

(52) U.S. Cl. 455/126; 343/893; 343/876

(57) ABSTRACT

An antenna apparatus includes: first high-frequency output means for outputting a first high-frequency signal; second high-frequency output means for outputting a second high-frequency signal having the same frequency component as that of the first high-frequency signal; first antenna means for emitting a right-hand elliptically polarized wave according to the first high-frequency signal output from the first high-frequency output means; second antenna means for emitting a left-hand elliptically polarized wave according to the second high-frequency signal output from the second high-frequency output means; and phase adjustment means for adjusting a phase of at least one of the first high-frequency signal output from the first high-frequency output means and the second high-frequency signal output from the second high-frequency output means.

### TECHNICAL FIELD

The present invention relates to an antenna apparatus, an antenna system, and a method of adjusting the antenna apparatus that are able to generate a linearly polarized wave having a desired polarization direction by a simple configuration.

### BACKGROUND ART

In recent years, there has been a growing need for gigabit-class high-speed radio used in an indoor environment. For example, the use of a high-frequency band (e.g., 60 GHz) has been promoted since it facilitates broadband transmission compared to a microwave band equal to or smaller than about 6 GHz which has been conventionally used. On the other hand, a radio wave in such a high-frequency band has characteristics that it has small diffraction and strong rectilinear propagation properties. Thus, when there is an obstruction between communication apparatuses that transmit and receive radio waves in the high-frequency band, there are caused problems that communication quality is deteriorated, and in particular, communication is interrupted in a millimeter waveband.

In order to solve the problems, for example, such a measure is taken to maintain the communication quality by using a reflected wave of a direct wave instead of using the direct wave when there is an obstruction between the communication apparatuses as described above. Meanwhile, it may be possible that the phase of an input radio wave by the reflected wave is inverted. Thus, the use of a circularly polarized wave in a transmitting antenna and a receiving antenna may dramatically decrease the reception power.

Accordingly, a linearly polarized wave is typically used in the reflected wave communication stated above. In this case, there are two main problems as follows. The first problem is that, when linearly polarized wave antennas are used in a transmitter and a receiver, the reception sensitivity becomes maximum if the polarization directions of the antennas are uniformly oriented, whereas the reception sensitivity may be deteriorated if there are deviations in the polarization directions. Further, when the reflected wave communication is executed in an indoor area (in particular, home environment), if there is a restriction in the positional relation in which the transmitter and the receiver are installed and it is required to keep the angles of the transmitting and receiving antennas constant in order to prevent this problem, it may dramatically impair convenience.

The second problem is that a reflectance of a reflector greatly varies according to the incident angle of the wave and the polarization direction that is used. For example, when a parallel polarized wave is used, it may be possible that the reception sensitivity cannot be obtained at a specific incident angle corresponding to Brewster's angle. This is because the reflectance of the reflector depends on the angle between the electrical field excitation direction of the linearly polarized wave and the reflection surface. In general, the reflection surface in an indoor area includes not only a horizontal or vertical reflection surface such as walls or floors but also an oblique reflection surface such as a sofa arranged indoors.

Since the environment in which radio waves propagate is easy to change in an indoor area due to the exit and entry of people, for example, it is preferable to secure a plurality of communication paths. In such a case, various reflection surfaces are used for each of the communication paths. Accordingly, in order to solve the two problems, it is required to vary the polarization direction. Further, when the polarized wave of the radio wave emitted from the communication partner is unknown, it is required not only to generate a linearly polarized wave, but also to generate right-hand and left-hand circularly polarized waves (or elliptically polarized waves).

An antenna apparatus including a polarized wave converter for converting the direction of a polarized wave emitted from an antenna element is known (see PTL 1). In this antenna apparatus, a circularly polarized wave emitted from the antenna element is converted into a linearly polarized wave by a polarized wave converter. Further, the polarization direction of the linearly polarized wave may be corrected by rotating the polarized wave converter.

### CITATION LIST

### Patent Literature

### PTL 1: Japanese Unexamined Patent Application Publication No. 10-84219

### PTL 2: Japanese Unexamined Patent Application Publication No. 2006-254112

### SUMMARY OF INVENTION

### Technical Problem

However, the antenna apparatus itself only generates the linearly polarized wave. When the polarization direction of the linearly polarized wave is corrected, it is required to mechanically change the direction of the polarized wave converter, which makes it difficult to achieve a high-speed operation. Further, the polarized wave converter is required in addition to the antenna element, resulting in a complicated configuration and an increase in cost.

On the other hand, as shown in FIG. 14, an antenna apparatus 140 is known including a high-frequency source 141, a branch circuit 142, phase shifters 143, power supply lines 144, a patch antenna 145 including a plurality of excitation units, and power amplifiers 146. A high-frequency signal output from the high-frequency source 141 is divided by the branch circuit 142, and the divided signals are input to the patch antenna 145 via the phase shifters 143 and the power supply lines 144. Two excitation units on the patch antenna 145 connected to the respective power supply lines 144 excite radiation electric fields that are orthogonal to each other. The phases of the high-frequency signals input to the two excitation units may have a phase difference of 0°, 90°, 180°, 270°, for example, by the phase shifters 143, and a linearly polarized wave and a circularly polarized wave are generated. Further, it is possible to adjust the polarization direction of the linearly polarized wave by controlling the input ratio to the patch antenna 145 by the power amplifiers 146.

The antenna apparatus 140 has an advantage that the polarized wave can be switched by an electrical operation without requiring a polarized wave converter. On the other hand, since two excitation units are provided in one patch antenna 145, it is required to connect the power supply lines to the respective excitation units, which may complicate the wiring. Furthermore, for example, when an antenna system is formed by combining a plurality of antenna apparatuses, the wiring is complicated with increasing the number of elements of the antenna. Meanwhile, an antenna apparatus including an antenna of left-hand polarized wave system and an antenna of right-hand polarized wave system is known (see PTL 2).

It is required to provide an antenna apparatus capable of generating a linearly polarized wave having an arbitrary polarization direction without requiring the special polarized wave converter or complicated wiring to antennas as described above.

The present invention has been made in view of the aforementioned problems, and mainly aims to provide an antenna apparatus, an antenna system, and a method of adjusting the antenna apparatus that are able to generate desired linearly polarized waves by a simple configuration.

### Solution to Problem

An exemplary aspect of the present invention to accomplish the exemplary objects above is an antenna apparatus including: first high-frequency output means for outputting a first high-frequency signal; second high-frequency output means for outputting a second high-frequency signal having the same frequency component as that of the first high-frequency signal; first antenna means for emitting a right-hand elliptically polarized wave according to the first high-frequency signal output from the first high-frequency output means; second antenna means for emitting a left-hand elliptically polarized wave according to the second high-frequency signal output from the second high-frequency output means; and phase adjustment means for adjusting a phase of at least one of the first high-frequency signal output from the first high-frequency output means and the second high-frequency signal output from the second high-frequency output means.

Another exemplary aspect of the present invention to accomplish the exemplary objects above may be an antenna apparatus including: high-frequency output means for outputting a high-frequency signal; branch means for dividing the high-frequency signal output from the high-frequency output means into two high-frequency signals having the same frequency component; first antenna means for emitting a left-hand elliptically polarized wave according to one of the two high-frequency signals divided by the branch means; second antenna means for emitting a right-hand elliptically polarized wave according to the other one of the two high-frequency signals divided by the branch means; and phase adjustment means for adjusting a phase of at least one of the high-frequency signal input to the first antenna means and the high-frequency signal input to the second antenna means.

Another exemplary aspect of the present invention to accomplish the exemplary objects above may be an antenna system including: a first antenna apparatus including: first high-frequency output means for outputting a first high-frequency signal; first branch means for dividing the first high-frequency signal output from the first high-frequency output means into two first high-frequency signals; first antenna means for simultaneously emitting linearly polarized waves that are orthogonal to each other from two excitation units according to the two first high-frequency signals divided by the first branch means, to generate a right-hand elliptically polarized wave; first phase adjustment means for adjusting a phase of at least one of the two first high-frequency signals to be input to the respective excitation units, and a second antenna apparatus including: second high-frequency output means for outputting a second high-frequency signal having the same frequency component as that of the first high-frequency signal; second branch means for dividing the second high-frequency signal output from the second high-frequency output means into two second high-frequency signals; second antenna means for simultaneously emitting linearly polarized waves that are orthogonal to each other from two excitation units according to the two second high-frequency signals divided by the second branch means, to generate a left-hand elliptically polarized wave; and second phase adjustment means for adjusting a phase of at least one of the two second high-frequency signals to be input to the respective excitation units.

Further exemplary aspect of the present invention to accomplish the exemplary objects above may be a method of adjusting an antenna apparatus including the steps of: outputting a first high-frequency signal; outputting a second high-frequency signal having the same frequency component as that of the first high-frequency signal; emitting a right-hand elliptically polarized wave according to the first high-frequency signal that is output; emitting a left-hand elliptically polarized wave according to the second high-frequency signal that is output; and adjusting a phase of at least one of the first high-frequency signal and the second high-frequency signal that are output.

### Advantageous Effects of Invention

According to the present invention, it is possible to provide an antenna apparatus, an antenna system, and a method of adjusting the antenna apparatus that are able to generate desired linearly polarized waves by a simple configuration.

### BRIEF DESCRIPTION OF DRAWINGS

FIG. 1 is a functional block diagram of an antenna apparatus according to an exemplary embodiment of the present invention;

FIG. 2 is a block diagram showing a schematic system configuration of an antenna apparatus according to a first exemplary embodiment of the present invention;

FIG. 3 is a diagram for describing input phases of first and second high-frequency signals input to first and second antennas;

FIG. 4 is a diagram for describing effects of the antenna apparatus according to the first exemplary embodiment of the present invention;

FIG. 5 is a diagram showing one example of polarization characteristics of polarized waves emitted from the first and second antennas;

FIG. 6 is a diagram showing one example of polarization characteristics of polarized waves emitted from the first and second antennas;

FIG. 7 is a block diagram showing a schematic system configuration of an antenna system according to a second exemplary embodiment of the present invention;

FIG. 8 is a block diagram showing a schematic system configuration of an antenna apparatus according to a third exemplary embodiment of the present invention;

FIG. 9 is a block diagram showing a schematic system configuration of an antenna apparatus according to a fourth exemplary embodiment of the present invention;

FIG. 10 is a block diagram showing a schematic system configuration of an antenna apparatus according to a fifth exemplary embodiment of the present invention;

FIG. 11 is a block diagram showing a variant example of the antenna apparatus according to the fifth exemplary embodiment of the present invention;

FIG. 12 is a block diagram showing a schematic system configuration of an antenna apparatus according to a sixth exemplary embodiment of the present invention;

FIG. 13 is a block diagram showing a schematic configuration of an antenna system according to a seventh exemplary embodiment of the present invention; and

FIG. 14 is a block diagram showing a schematic system configuration of a related antenna apparatus.

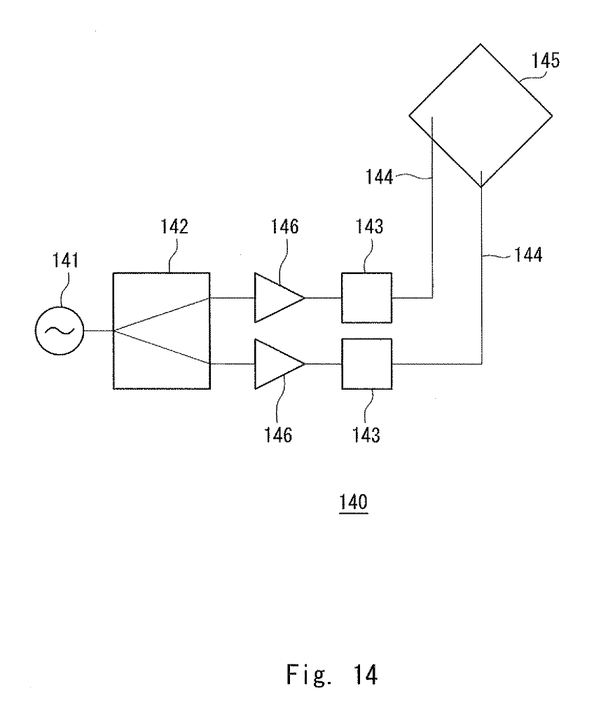

### DESCRIPTION OF EMBODIMENTS

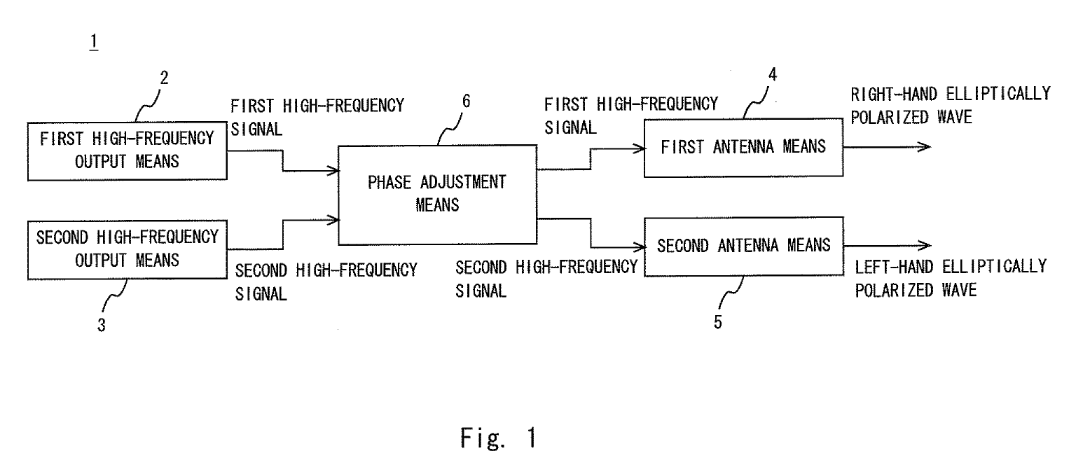

Hereinafter, with reference to the drawings, exemplary embodiments of the present invention will be described. FIG. 1 is a functional block diagram of an antenna apparatus according to an exemplary embodiment of the present invention. An antenna apparatus 1 according to this exemplary embodiment includes a first high-frequency output means 2 for outputting a first high-frequency signal, a second high-frequency output means 3 for outputting a second high-frequency signal having the same frequency component as that of the first high-frequency signal, a first antenna means 4 for emitting a right-hand elliptically polarized wave according to the first high-frequency signal output from the first high-frequency output means 2, a second antenna means 5 for emitting a left-hand elliptically polarized wave according to the second high-frequency signal output from the second high-frequency output means 3, and a phase adjustment means 6 for adjusting a phase of at least one of the first high-frequency signal output from the first high-frequency output means 2 and the second high-frequency signal output from the second high-frequency output means 3.

In the simple configuration stated above, the phase adjustment means 6 adjusts the phase of at least one of the first and second high-frequency signals. Then, a linearly polarized wave having a desired polarization direction is synthesized by the right-hand elliptically polarized wave emitted from the first antenna means 4 according to the first high-frequency signal that is adjusted and the left-hand elliptically polarized wave emitted from the second antenna means 5 according to the second high-frequency signal that is adjusted.

### FIRST EXEMPLARY EMBODIMENT

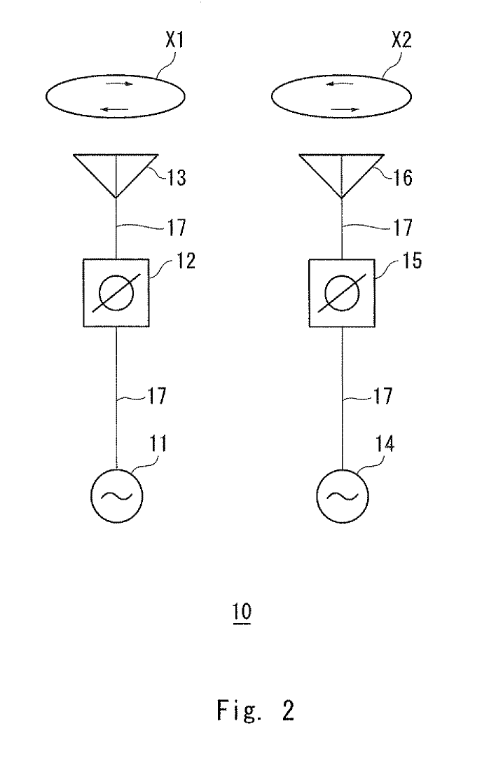

Hereinafter, with reference to the drawings, exemplary embodiments of the present invention will be described. FIG. 2 is a block diagram showing a schematic system configuration of an antenna apparatus according to a first exemplary embodiment of the present invention. An antenna apparatus 10 according to the first exemplary embodiment includes a first high-frequency source 11, a first phase adjustment mechanism 12, a first antenna 13, a second high-frequency source 14, a second phase adjustment mechanism 15, a second antenna 16, and a pair of power supply lines 17.

Note that the antenna apparatus 10 is formed in hardware to mainly include a microcomputer including a CPU (Central Processing Unit) for performing control processing, operation processing and the like, a ROM (Read Only Memory) for storing a control program, an operation program and the like executed by the CPU, and a RAM (Random Access Memory) for storing processing data and the like, for example.

The first high-frequency source 11 is one specific example of the first high-frequency output means 2, and generates a first high-frequency signal in the band of 60 GHz, for example. Further, the first antenna 13 is connected to the first high-frequency source 11 via the power supply line 17, and the first high-frequency source 11 outputs the first high-frequency signal that is generated to the first antenna 13.

The first phase adjustment mechanism 12 is one specific example of the phase adjustment means 6, and is provided in the power supply line 17 that connects the first high-frequency source 11 and the first antenna 13. The first phase adjustment mechanism 12 is able to continuously change the phase of the first high-frequency signal to be input to the first antenna 13 in a range from 0 to 360 degrees. The first high-frequency signal output from the first high-frequency source 11 is adjusted by the first phase adjustment mechanism 12, and is then input to the first antenna 13.

The first antenna 13 is one specific example of the first antenna means 4, and emits a right-hand elliptically polarized wave X1 according to the first high-frequency signal adjusted by the first phase adjustment mechanism 12.

The second high-frequency source 14 is one specific example of the second high-frequency output means 3, and generates a second high-frequency signal having the same frequency component as that of the first high-frequency signal. Further, the second antenna 16 is connected to the second high-frequency source 14 via the power supply line 17, and the second high-frequency source 14 outputs the second high-frequency signal that is generated to the second antenna 16.

The second phase adjustment mechanism 15 is one specific example of the phase adjustment means 6, and is provided in the power supply line 17 that connects the second high-frequency source 14 and the second antenna 16. The second phase adjustment mechanism 15 is able to continuously change the phase of the second high-frequency signal to be input to the second antenna 16 in a range from 0 to 360 degrees. The second high-frequency signal output from the second high-frequency source 14 is adjusted by the second phase adjustment mechanism 15, and is then input to the second antenna 16.

The second antenna 16 is one specific example of the second antenna means 5, and emits a left-hand elliptically polarized wave X2 according to the second high-frequency signal adjusted by the second phase adjustment mechanism 15. Then, a linearly polarized wave having an arbitrary polarization direction (excitation direction) is synthesized, for example, by the right-hand elliptically polarized wave X1 emitted from the first antenna 13 and the left-hand elliptically polarized wave X2 emitted from the second antenna 16.

As described above, the first high-frequency signal and the second high-frequency signal have the same frequency component. Accordingly, the right-hand elliptically polarized wave X1 based on the first high-frequency signal emitted from the first antenna 13 and the left-hand elliptically polarized wave X2 based on the second high-frequency signal emitted from the second antenna 16 are cancelled with each other, whereby the linearly polarized wave having the arbitrary polarization direction is synthesized.

In the first exemplary embodiment, the first and second antennas 13 and 16 are connected to the first and second high-frequency sources 11 and 14, respectively, via the pair of power supply lines 17. However, it is not limited to this example. Any desired configuration may be employed as long as the first and second high-frequency signals having the same frequency component can be input to the first and second antennas 13 and 16, respectively.

Further, the antenna apparatus 10 according to the first exemplary embodiment may have a configuration of including only one of the first and second phase adjustment mechanisms 12 and 15. Further, the phases of the first and second high-frequency signals may be adjusted by adjusting the length of each power supply line 17.

Further, the first antenna 13 may emit the left-hand elliptically polarized wave, and the second antenna 16 may emit the right-hand elliptically polarized wave. In short, it is only required that the first antenna 13 and the second antenna 16 emit elliptically polarized waves that are rotated in the opposite directions to each other. Further, while the first and second antennas 13 and 16 emit the elliptically polarized waves X1 and X2, respectively, it is not limited to this example. Each of the first and second antennas 13 and 16 may emit a circularly polarized wave which is one of the elliptically polarized wave.

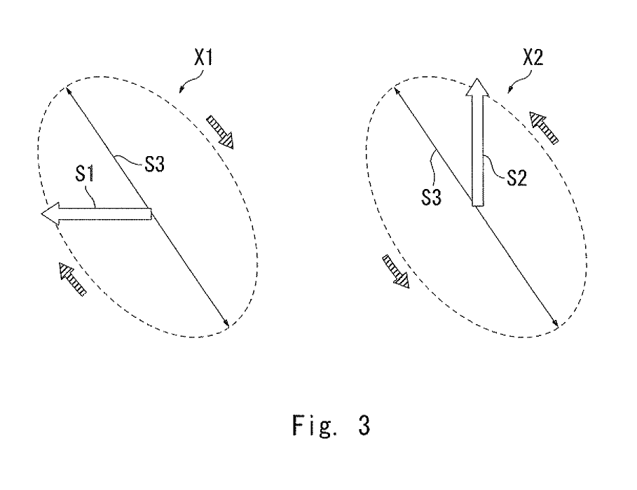

Next, with reference to FIG. 3, input phases of the first and second high-frequency signals input to the first and second antennas 13 and 16 will be described in detail. For example, the first phase adjustment mechanism 12 sets the input phase of the first high-frequency signal input to the first antenna 13, and the second phase adjustment mechanism 15 sets the input phase of the second high-frequency signal input to the second antenna 16 on the basis of the input phase of the first high-frequency signal. In this way, the input phase difference between the first high-frequency signal input to the first antenna 13 and the second high-frequency signal input to the second antenna 16 is set.

For example, as shown in FIG. 3, when an electric field direction S1 in the initial phase of the right-hand elliptically polarized wave X1 emitted from the first antenna 13 is denoted by A0 degrees, an electric field direction S2 in the initial phase of the left-hand elliptically polarized wave X2 emitted from the second antenna 16 is denoted by A1 degrees, a desired polarization direction S3 of the linearly polarized wave synthesized by the right-hand elliptically polarized wave X1 and the left-hand elliptically polarized wave X2 is denoted by B degrees, and N is any integer, the input phase difference between the first high-frequency signal input to the reference first antenna 13 and the second high-frequency signal input to the second antenna 16 can be expressed by the following formula (1).

input phase difference=2B−A0−A1±2N×180 (degrees) (1)

While the antenna apparatus 10 according to the first exemplary embodiment has a configuration of including two first and second antennas 13 and 16 for emitting the elliptically polarized waves X1 and X2 that are rotated in the opposite directions to each other for the purpose of simplifying the description, the number of antenna elements that are formed may be three or more.

However, in order to sufficiently increase the axial ratio of the linearly polarized wave that is synthesized, the number of antenna elements for emitting the right-hand elliptically polarized wave X1 and the number of antenna elements for emitting the left-hand elliptically polarized wave X2 are preferably the same. In this case, assuming that the initial electric field direction is A2 degrees, the input phase difference between the reference antenna element and the antenna element for emitting the elliptically polarized wave which rotates in the same direction as the reference antenna element can be expressed by the following formula (2). The input phase difference is substantially equal to that in the case in which the initial electric field direction is set to A0 degrees.

input phase difference=A0−A2±2N×180(degrees) (2)

Further, when the polarization direction of the linearly polarized wave is changed, the first and second phase adjustment mechanisms 12 and 15 are able to set the input phase difference between the first antenna 13 and the second antenna 16 as follows. That is, the first and second phase adjustment mechanisms 12 and 15 adjust the input phase difference between the first high-frequency signal input to the first antenna 13 and the second high-frequency signal input to the second antenna 16 to a value obtained by adding a phase difference 41 to the input phase difference calculated in the above formula (1), or a value obtained by adding a phase difference 42 to the input phase difference calculated in the above formulae (1) and (2). As a result, the polarization direction of the linearly polarized wave synthesized from the right-hand elliptically polarized wave X1 emitted from the first antenna 13 and the left-hand elliptically polarized wave X2 emitted from the second antenna 16 is set to B+(Δ1+Δ2)/2.

While the input phase difference between the first high-frequency signal input to the first antenna 13 and the second high-frequency signal input to the second antenna 16 is adjusted using the first and second phase adjustment mechanisms 12 and 15, it is not limited to this example. For example, the input phase difference may be adjusted using phase shifters, variable capacitances, variable inductors or the like. According to the configuration above, the antenna apparatus 10 according to the first exemplary embodiment is able to generate the linearly polarized wave having the arbitrary polarization direction by the simple configuration without requiring a special polarized wave converter or complicated wiring to antennas.

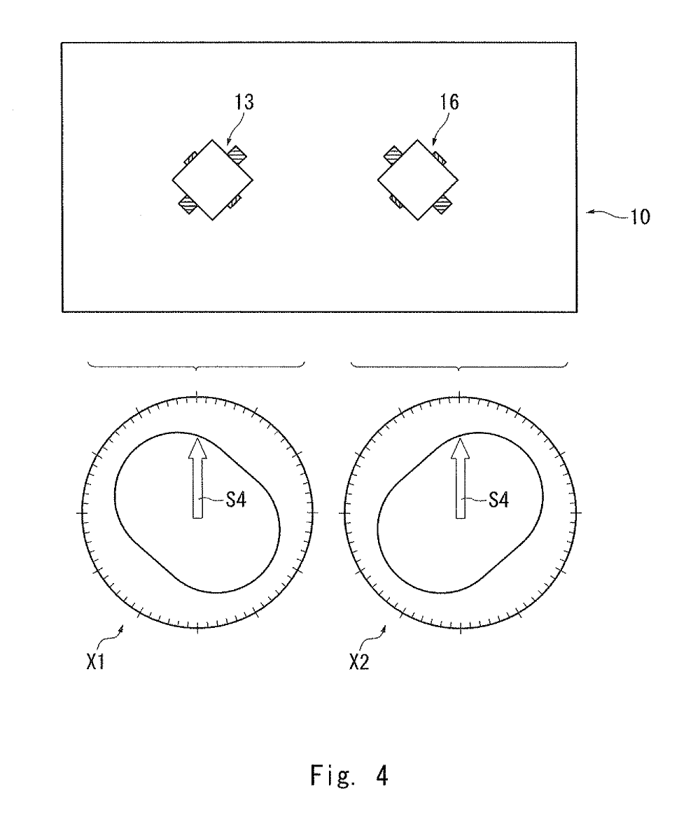

Next, the effects of the antenna apparatus 10 according to the first exemplary embodiment will be described in detail. As shown in FIG. 4, in the antenna apparatus 10 according to the first exemplary embodiment, each of the first and second antennas 13 and 16 is formed as a patch antenna, for example, and the patch antennas emit the elliptically polarized waves X1 and X2 that are rotated in the opposite directions to each other.

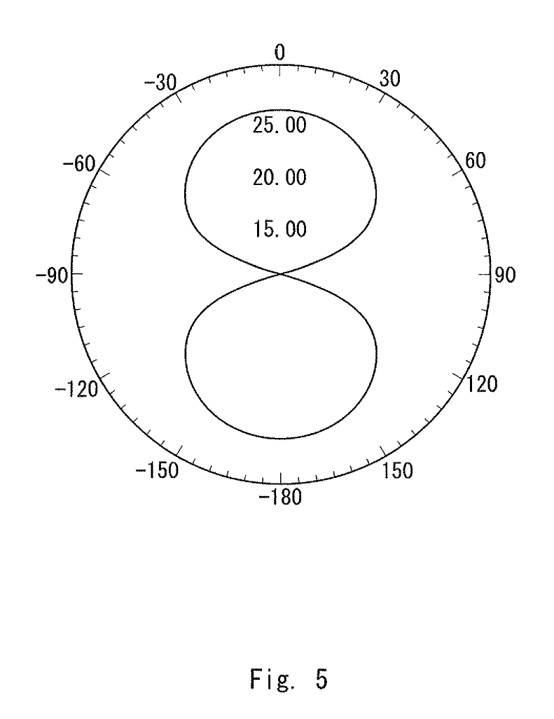

FIG. 5 shows polarization characteristics when an initial electric field direction S4 of each of the elliptically polarized waves X1 and X2 from the first and second antennas 13 and 16 is set to 0 degrees. Further, FIG. 5 shows changes in received electric field strength when a emitted electromagnetic wave is received by an ideal antenna for linearly polarized wave in the vertical direction of the antenna apparatus 10 and the receiving antenna is rotated. Further, in FIG. 5, the radial direction indicates the intensity of the electric field. The electric field in the directions of 0 degrees and 180 degrees is the maximum, and the electric field in the directions of 90 degrees and 270 degrees is the minimum. The polarized wave ratio is about 27 dB, and a vertically polarized wave is generated.

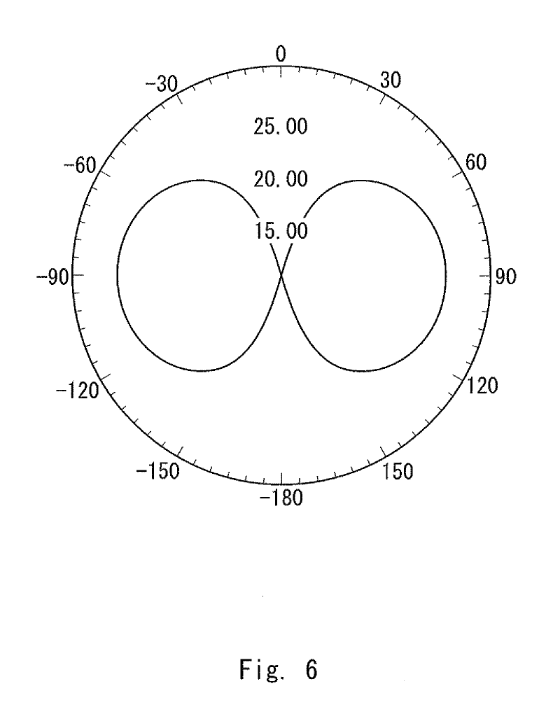

Meanwhile, FIG. 6 is a diagram showing one example of polarization characteristics when the input phase difference between the first antenna 13 and the second antenna 16 is adjusted and the initial electric field direction S4 of each of the elliptically polarized waves X1 and X2 is set to 90 degrees. Further, in FIG. 6, the radial direction indicates the intensity of the electric field. The electric field in the directions of 90 degrees and 270 degrees is the maximum, and a horizontally polarized wave is generated. At this time, the polarized wave ratio is about 27 dB.

As described above, the antenna apparatus 10 according to the first exemplary embodiment is able to synthesize the linearly polarized wave having an arbitrary polarization direction by the simple configuration.

### SECOND EXEMPLARY EMBODIMENT

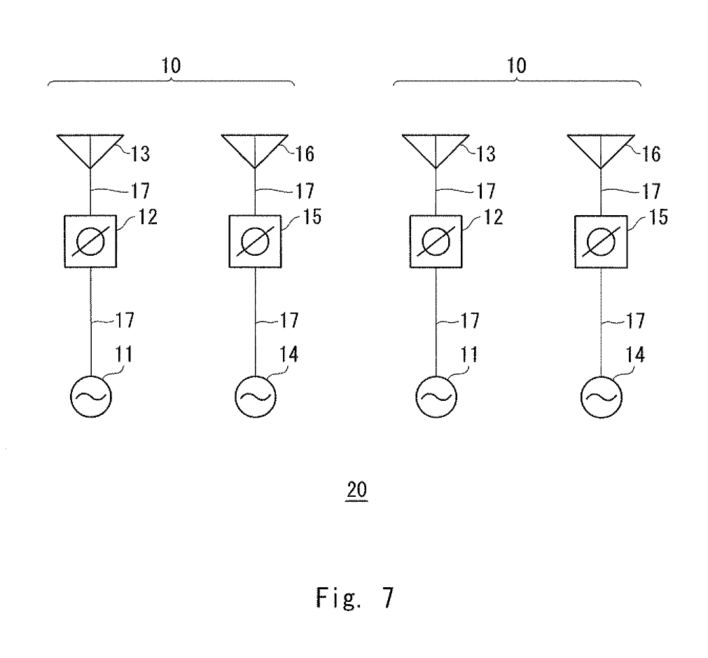

FIG. 7 is a block diagram showing a schematic system configuration of an antenna system according to a second exemplary embodiment of the present invention. An antenna system 20 according to the second exemplary embodiment includes a pair of antenna apparatuses 10 according to the first exemplary embodiment. The first and second phase adjustment mechanisms 12 and 15 of each antenna apparatus 10 adjust the input phase difference between the first high-frequency signal input to the first antenna 13 and the second high-frequency signal input to the second antenna 16, whereby it is possible to generate a linearly polarized wave having an arbitrary polarization direction and to further execute beam scanning by a beam steering function.

When the antenna system 20 executes the beam steering function, the first and second phase adjustment mechanisms 12 and 15 of each antenna apparatus 10 calculate the phase difference obtained by adding an input phase difference that is required for the beam steering function to an input phase difference that is required to determine the polarization direction of the linearly polarized wave. Then, the first and second phase adjustment mechanisms 12 and 15 perform adjustment so that the input phase difference between the first high-frequency signal input to the first antenna 13 and the second high-frequency signal input to the second antenna 16 is equal to the phase difference that is calculated above. The input phase difference that is required to determine the polarization direction can be calculated by the similar method as that described in the first exemplary embodiment.

In the antenna system 20 according to the second exemplary embodiment, the same components as those in the antenna apparatus 10 according to the first exemplary embodiment are denoted by the same reference symbols, and detailed description will be omitted.

### THIRD EXEMPLARY EMBODIMENT

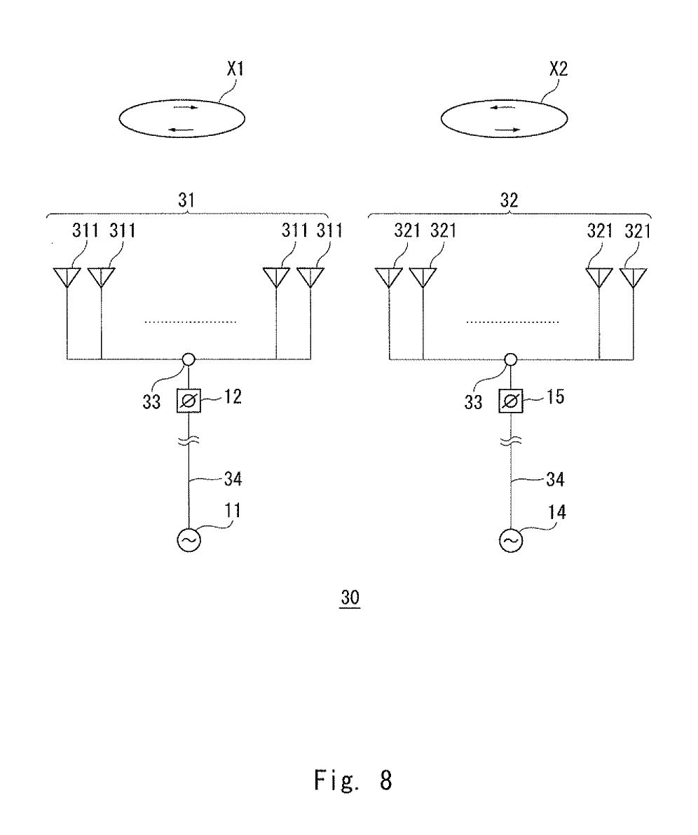

FIG. 8 is a block diagram showing a schematic system configuration of an antenna apparatus according to a third exemplary embodiment of the present invention. In an antenna apparatus 30 according to the third exemplary embodiment, first and second antennas 31 and 32 are formed as array antennas formed of a plurality of antenna elements 311 and 321. Each of the antenna elements 311 of the first antenna 31 and each of the antenna elements 321 of the second antenna 32 are connected to the first high-frequency source 11 and the second high-frequency source 14, respectively, via branch units 33 and power supply lines 34.

The phase of the first high-frequency signal output from the first high-frequency source 11 is adjusted by the first phase adjustment mechanism 12. The first high-frequency signal that is adjusted is divided by the branch unit 33, and the divided signals are input to the respective antenna elements 311 of the first antenna 31. Accordingly, each of the antenna elements 311 of the first antenna 31 emits the right-hand elliptically polarized wave X1 according to the first high-frequency signal that is input.

In the similar way, the phase of the second high-frequency signal output from the second high-frequency source 14 is adjusted by the second phase adjustment mechanism 15. The second high-frequency signal that is adjusted is divided by the branch unit 33, and then the divided signals are input to the respective antenna elements 321 of the second antenna 32. Accordingly, each of the antenna elements 321 of the second antenna 32 emits the left-hand elliptically polarized wave X2 according to the second high-frequency signal that is input.

Further, the first and second antennas 31 and 32 each have a sequential array structure, for example, and generate the elliptically polarized waves X1 and X2, respectively, by forming the plurality of antenna elements 311 and 321 in arrays. Further, the input phase difference that is required to determine the polarization direction of the linearly polarized wave can be obtained in the similar way as in the first exemplary embodiment by assuming the first and second antennas 31 and 32 as a single antenna element.

For example, the first and second phase adjustment mechanisms 12 and 15 adjust the input phase difference between the first high-frequency signal to be input to the first antenna 31 and the second high-frequency signal to be input to the second antenna 32, thereby being able to change the polarization direction of the linearly polarized wave. Further, the first and second phase adjustment mechanisms 12 and 15 adjust the input phase difference between the first high-frequency signal to be input to the first antenna 31 and the second high-frequency signal to be input to the second antenna 32 to the phase difference obtained by adding the input phase difference that is required to determine the polarization direction and the input phase difference that is required for the beam steering function, thereby being able to execute the beam steering function while generating the linearly polarized wave having a desired polarization direction.

In the antenna apparatus 30 according to the third exemplary embodiment, the other configurations are substantially the same to those of the antenna apparatus 10 according to the first exemplary embodiment. Thus, the same components are denoted by the same reference symbols, and detailed description will be omitted.

### FOURTH EXEMPLARY EMBODIMENT

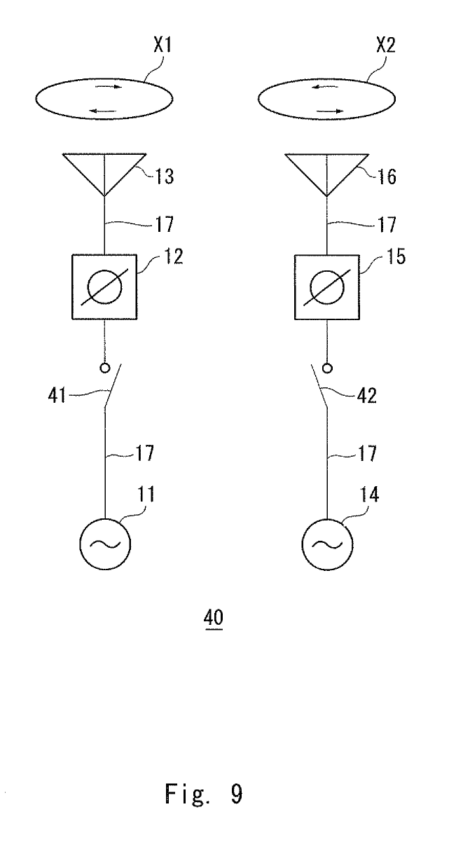

FIG. 9 is a block diagram showing a schematic system configuration of an antenna apparatus according to a fourth exemplary embodiment of the present invention. An antenna apparatus 40 according to the fourth exemplary embodiment further includes a first switch 41 for switching the first high-frequency source 11 and the first antenna 13 to a connection state and a non-connection state, and a second switch 42 for switching the second high-frequency source 14 and the second antenna 16 to the connection state and the non-connection state.

The first switch 41 is one specific example of switch means, and is provided in the power supply line 17 between the first high-frequency source 11 and the first phase adjustment mechanism 12. In the similar way, the second switch 42 is one specific example of the switch means, and is provided in the power supply line 17 between the second high-frequency source 14 and the second phase adjustment mechanism 15.

The antenna apparatus 40 may have a configuration of including only one of the first and second switches 41 and 42. Further, the first and second switches 41 and 42 may be provided in the power supply line 17 between the first and second antennas 13 and 16 and the power supply line 17 between the first and second phase adjustment mechanisms 12 and 15, respectively.

For example, when the first switch 41 is in the connection state (ON state) and the second switch 42 is in the non-connection state (OFF state), the first high-frequency signal output from the first high-frequency source 11 is supplied to the first antenna 13 via the first switch 41, and the right-hand elliptically polarized wave X1 is emitted from the first antenna 13.

Further, when the first switch 41 is in the non-connection state and the second switch 42 is in the connection state, the second high-frequency signal output from the second high-frequency source 14 is supplied to the second antenna 16 via the second switch 42, and the left-hand elliptically polarized wave X2 is emitted from the second antenna 16.

Further, when the first switch 41 is in the connection state and the second switch 42 is in the connection state, the first high-frequency signal output from the first high-frequency source 11 is supplied to the first antenna 13 via the first switch 41, and the right-hand elliptically polarized wave X1 is emitted from the first antenna 41. At the same time, the second high-frequency signal output from the second high-frequency source 14 is supplied to the second antenna 16 via the second switch 42, and the left-hand elliptically polarized wave X2 is emitted from the second antenna 16. Then, the right-hand elliptically polarized wave X1 and the left-hand elliptically polarized wave X2 are synthesized, thereby generating the linearly polarized wave having an arbitrary polarization direction.

In the antenna apparatus 40 according to the fourth exemplary embodiment, other configurations are substantially similar to those of the antenna apparatus 10 according to the first exemplary embodiment. Thus, the same components are denoted by the same reference symbols, and detailed description thereof will be omitted.

As described above, the antenna apparatus 40 according to the fourth exemplary embodiment is not only able to synthesize the linearly polarized wave having an arbitrary polarization direction by the simple configuration, but also to appropriately switch the connections to emit the right-hand and left-hand elliptically polarized waves X1 and X2. While the antenna apparatus 40 according to the fourth exemplary embodiment has a configuration of including two first and second antennas 13 and 16 for emitting the elliptically polarized waves X1 and X2 that are rotated in the opposite directions to each other, it is not limited to this example. The antenna apparatus 40 may have a configuration of including three or more antennas for emitting the elliptically polarized waves X1 and X2 that are rotated in the opposite directions to each other.

Further, when there is no obstruction between a transmitter and a receiver and a line of sight is secured, the influence of multipath may be suppressed by using the elliptically polarized wave (or circularly polarized wave) as described above. For example, it is possible to appropriately change the radio system or the circuit as well as the polarized wave, and to efficiently achieve low power consumption by not using an equalizer or the like or by using other modulation systems from an OFDM (Orthogonal Frequency Division Multiplexing) which has multipath resistance but consumes high power.

### FIFTH EXEMPLARY EMBODIMENT

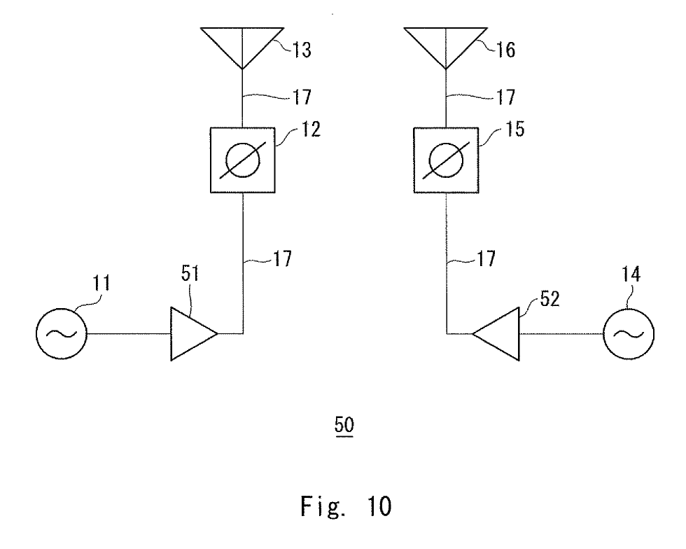

FIG. 10 is a block diagram showing a schematic system configuration of an antenna apparatus according to a fifth exemplary embodiment of the present invention. An antenna apparatus 50 according to the fifth exemplary embodiment further includes a first power amplifier 51 for adjusting a radiation output of the first antenna 13, and a second power amplifier 52 for adjusting a radiation output of the second antenna 16.

The first power amplifier 51 is one specific example of power adjustment means, and is provided in the power supply line 17 between the first high-frequency source 11 and the first phase adjustment mechanism 12. In the similar way, the second power amplifier 52 is one specific example of the power adjustment means, and is provided in the power supply line 17 between the second high-frequency source 14 and the second phase adjustment mechanism 15. The antenna apparatus 50 may have a configuration of including only one of the first and second power amplifiers 51 and 52. Further, the first and second power amplifiers 51 and 52 may have a configuration in which they are provided in the power supply line 17 between the first and second antennas 13 and 16 and the power supply line 17 between the first and second phase adjustment mechanisms 12 and 15, respectively.

Further, while the antenna apparatus 50 includes two first and second antennas 13 and 16, it is not limited to this but may have a configuration of including three or more antennas.

In the antenna apparatus 50 according to the fifth exemplary embodiment, other configurations are substantially similar to those of the antenna apparatus 10 according to the first exemplary embodiment. Thus, the same components are denoted by the same reference symbols, and detailed description thereof will be omitted.

As described above, the antenna apparatus 50 according to the fifth exemplary embodiment makes it possible not only to generate the linearly polarized wave having an arbitrary polarization direction by the simple configuration, but also to adjust the radiation outputs of the first and second antennas 13 and 16. For example, when the distance between the transmitter and the receiver becomes longer and it is impossible to obtain sufficient transmission power and reception power, it is possible to reliably keep the communication by amplifying the radiation power by the first and second power amplifiers 51 and 52. In contrast, when the distance between the transmitter and the receiver becomes shorter and it is possible to obtain sufficient transmission power and reception power, it is possible to save power by reducing the radiation power to the necessary level by the first and second power amplifiers 51 and 52.

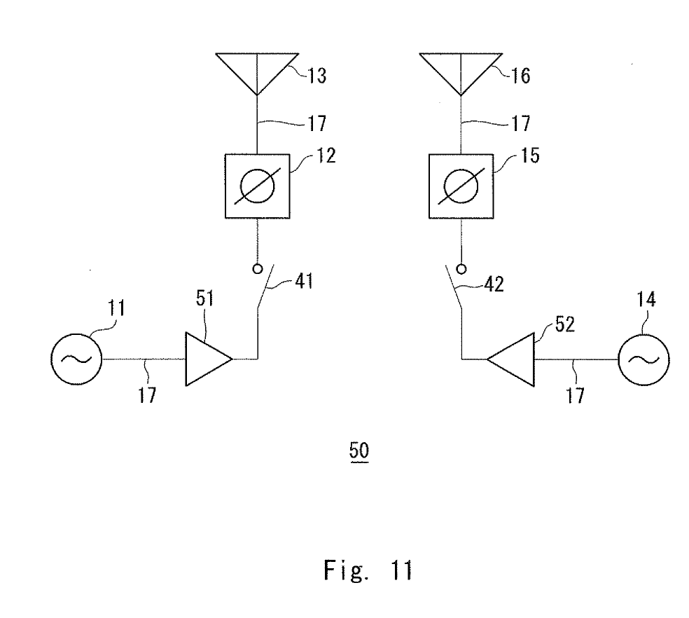

Note that the antenna apparatus 50 according to the fifth exemplary embodiment may have a configuration of including first and/or second switches 41 and 42 (FIG. 11) as is similar to the antenna apparatus 40 according to the fourth exemplary embodiment. Accordingly, it is possible not only to adjust the radiation outputs of the first and second antennas 13 and 16 by the simple configuration, but also to synthesize the linearly polarized wave having an arbitrary polarization direction or to switch the connections appropriately to emit the right-hand and left-hand elliptically polarized waves X1 and X2.

### SIXTH EXEMPLARY EMBODIMENT

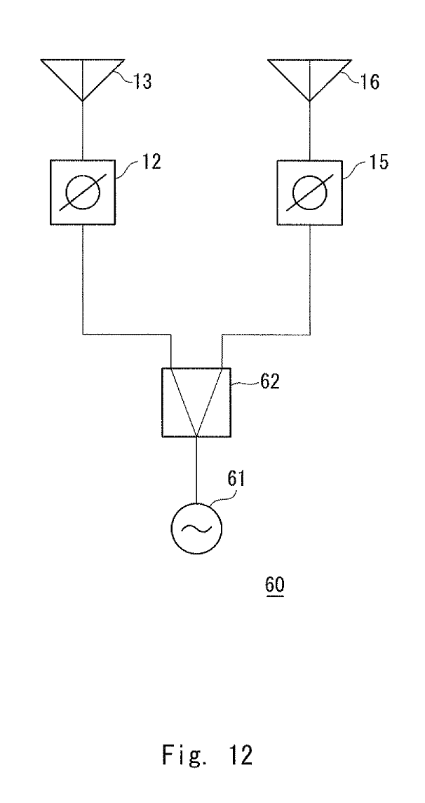

FIG. 12 is a block diagram showing a schematic system configuration of an antenna apparatus according to a sixth exemplary embodiment of the present invention. An antenna apparatus 60 according to the sixth exemplary embodiment includes a high-frequency source 61, a branch circuit 62, a first phase adjustment mechanism 12, a first antenna 13, a second phase adjustment mechanism 15, and a second antenna 16.

The high-frequency source 61 is one specific example of high-frequency output means. The high-frequency source 61 generates a high-frequency signal to output the generated signal to the branch circuit 62. The branch circuit 62 is one specific example of branch means, and divides the high-frequency signal output from the high-frequency source 61 into two high-frequency signals having the same frequency component. The antenna apparatus 60 according to the sixth exemplary embodiment may have such a configuration in which it does not include the branch circuit 62 if it is possible to generate two high-frequency signals having the same frequency component.

The first antenna 13 emits the right-hand elliptically polarized wave X1 according to a first high-frequency signal divided by the branch circuit 62. Further, the second antenna 16 emits the left-hand elliptically polarized wave X2 according to a second high-frequency signal that is divided by the branch circuit 62.

The first phase adjustment mechanism 12 adjusts the phase of the first high-frequency signal that is divided by the branch circuit 62 and is to be input to the first antenna 13. In the similar way, the second phase adjustment mechanism 15 adjusts the phase of the second high-frequency signal that is divided by the branch circuit 62 and is to be input to the second antenna 16. Note that the antenna apparatus 60 according to the sixth exemplary embodiment may have a configuration of including only one of the first and second phase adjustment mechanisms 12 and 15.

The antenna apparatus 60 according to the sixth exemplary embodiment makes it possible to reduce the number of high-frequency sources, which makes it possible to further simplify the configuration. Further, it is possible to achieve the similar effect as in the first exemplary embodiment: synthesizing the linearly polarized wave having an arbitrary polarization direction by the simple configuration.

In the antenna apparatus 60 according to the sixth exemplary embodiment, other configurations are substantially the same to those of the antenna apparatus 10 according to the first exemplary embodiment. Thus, the same components are denoted by the same reference symbols and detailed description will be omitted.

### SEVENTH EXEMPLARY EMBODIMENT

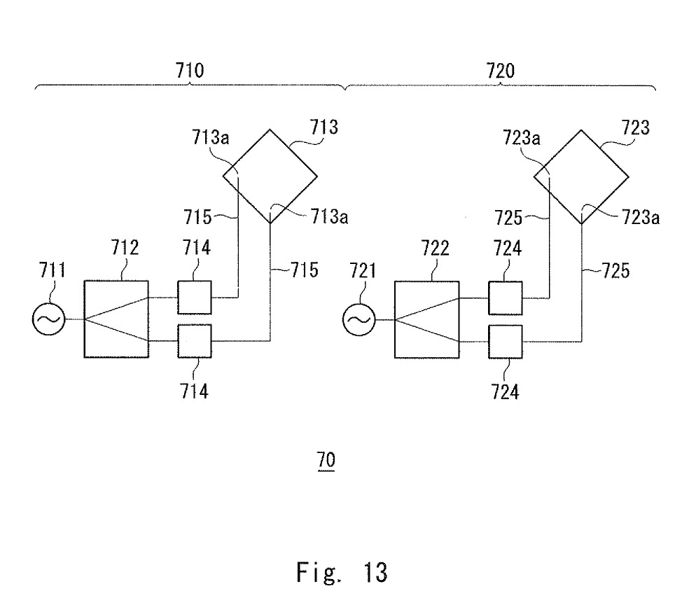

FIG. 13 is a block diagram showing a schematic configuration of an antenna system according to a seventh exemplary embodiment of the present invention. An antenna system 70 according to the seventh exemplary embodiment includes a first antenna apparatus 710 and a second antenna apparatus 720.

The first antenna apparatus 710 includes a first high-frequency source 711, a first branch circuit 712, a first antenna 713, and a pair of first phase adjustment mechanisms 714.

The first high-frequency source 711 is one specific example of a first high-frequency output means. The first high-frequency source 711 generates a first high-frequency signal to output the generated signal to the first branch circuit 712. The first branch circuit 712 is one specific example of a first branch means. The first branch circuit 712 divides the first high-frequency signal output from the first high-frequency source 711 into two signals, and outputs each of the two signals to the first antenna 713.

The first antenna 713 is one specific example of a first antenna means. The first antenna 713 includes a pair of excitation units 713a that receive two first high-frequency signals divided by the first branch circuit 712, and generates a right-hand elliptically polarized wave.

The pair of first phase adjustment mechanisms 714 are one specific example of a first phase adjustment means, and adjust the phases of the first high-frequency signals to be input to the respective excitation units 713a of the first antenna 713. The first phase adjustment mechanisms 714 are provided in the respective power supply lines 715 between the first branch circuit 712 and the first antenna 713. In the seventh exemplary embodiment, only one of the pair of first phase adjustment mechanisms 714 may be provided.

The excitation units 713a of the first antenna 713 simultaneously emit linearly polarized waves that are orthogonal to each other according to the first high-frequency signals that are divided by the first branch circuit 712 and adjusted by the first phase adjustment mechanisms 714, to synthesize the right-hand elliptically polarized wave X1. Further, the first phase adjustment mechanisms 714 are able to properly correct the input phase error of the first high-frequency signals input to the respective excitation units 713a of the first antenna 713, to improve the axial ratio of the right-hand elliptically polarized wave X1 that is generated.

The second antenna apparatus 720 has substantially the same configuration as that of the first antenna apparatus 710. In summary, the second antenna apparatus 720 includes a second high-frequency source 721, a second branch circuit 722, a second antenna 723, and a pair of second phase adjustment mechanisms 724.

The second high-frequency source 721 is one specific example of a second high-frequency output means. The second high-frequency source 721 generates a second high-frequency signal having the same frequency component as that of the first high-frequency signal, and outputs the generated signal to the second branch circuit 722. The second branch circuit 722 is one specific example of a second branch means. The second branch circuit 722 divides the second high-frequency signal output from the second high-frequency source 721 into two signals, and outputs the signals to the second antenna 723.

The second antenna 723 is one specific example of a second antenna means. The second antenna 723 includes a pair of excitation units 723a that receive two second high-frequency signals divided by the second branch circuit 722, and generates a left-hand elliptically polarized wave.

The pair of second phase adjustment mechanisms 724 are one specific example of second phase adjustment means, and adjust the phases of the second high-frequency signals to be input to the respective excitation units 723a of the second antenna 723. The second phase adjustment mechanisms 724 are provided in the respective power supply lines 725 between the second branch circuit 722 and the second antenna 723. In the seventh exemplary embodiment, only one of the pair of second phase adjustment mechanisms 724 may be provided.

The excitation units 723a of the second antenna 723 simultaneously emit linearly polarized waves that are orthogonal to each other according to the second high-frequency signals that are divided by the second branch circuit 722 and adjusted by the second phase adjustment mechanisms 724, to synthesize the left-hand elliptically polarized wave X2. Further, the second phase adjustment mechanisms 724 are able to properly correct the input phase error of the second high-frequency signals input to the respective excitation units 723a of the second antenna 723, to improve the axial ratio of the left-hand elliptically polarized wave X2 that is generated.

The first and second phase adjustment mechanisms 714 and 724 set the input phase difference between the first and second high-frequency signals input to the first and second antennas 713 and 723 so that the elliptically polarized waves X1 and X2 generated by the first and second antennas 713 and 723 reinforce each other, for example.

While the first and second antennas 713 and 723 are formed as patch antennas including a pair of excitation units 713a and a pair of excitation units 723a, it is not limited to this example. Any configuration may be applied if it is possible to simultaneously emit linearly polarized waves that are orthogonal to each other. Further, while the antenna system 70 includes two first and second antenna apparatuses 710 and 720, it is not limited to this. The antenna system 70 may be formed of three or more antenna apparatuses.

As described above, the antenna system 70 according to the seventh exemplary embodiment is able to improve the axial ratio of the elliptically polarized waves X1 and X2 generated by the first and second antennas 713 and 723. Further, the antenna system 70 according to the seventh exemplary embodiment is able to achieve the same effect as in the first exemplary embodiment: synthesizing the linearly polarized wave having an arbitrary polarization direction by the simple configuration.

Note that the present invention is not limited to the exemplary embodiments stated above, but may be changed as appropriate without departing from the spirit of the present invention. For example, the first to seventh exemplary embodiments may be combined as desired, to form the antenna apparatus and the antenna system.

Further, a part or all of the aforementioned exemplary embodiments may be described as in the following Supplementary Notes. However, it is not limited to them.
(Supplementary Note 1) An antenna apparatus comprising: first high-frequency output means for outputting a first high-frequency signal; second high-frequency output means for outputting a second high-frequency signal having the same frequency component as that of the first high-frequency signal; first antenna means for emitting a right-hand elliptically polarized wave according to the first high-frequency signal output from the first high-frequency output means; second antenna means for emitting a left-hand elliptically polarized wave according to the second high-frequency signal output from the second high-frequency output means; and phase adjustment means for adjusting a phase of at least one of the first high-frequency signal output from the first high-frequency output means and the second high-frequency signal output from the second high-frequency output means.
(Supplementary Note 2) The antenna apparatus according to (Supplementary Note 1), wherein each of the first antenna means and the second antenna means is an array antenna including a plurality of antenna elements.
(Supplementary Note 3) The antenna apparatus according to (Supplementary Note 1) or (Supplementary Note 2), further comprising switch means for switching at least one of a connection between the first high-frequency output means and the first antenna means and a connection between the second high-frequency output means and the second antenna means to a connection state and a non-connection state.
(Supplementary Note 4) The antenna apparatus according to any one of (Supplementary Note 1) to (Supplementary Note 3), further comprising power adjustment means for adjusting a radiation output of at least one of the first antenna means and the second antenna means.
(Supplementary Note 5) An antenna apparatus including: high-frequency output means for outputting high-frequency signal; branch means for dividing the high-frequency signal output from the high-frequency output means into two high-frequency signals having the same frequency component; first antenna means for emitting a left-hand elliptically polarized wave according to one of the two high-frequency signals divided by the branch means; second antenna means for emitting a right-hand elliptically polarized wave according to the other one of the two high-frequency signals divided by the branch means; and phase adjustment means for adjusting a phase of at least one of the high-frequency signal input to the first antenna means and the high-frequency signal input to the second antenna means.
(Supplementary Note 6) An antenna system comprising: a first antenna apparatus comprising: first high-frequency output means for outputting a first high-frequency signal; first branch means for dividing the first high-frequency signal output from the first high-frequency output means into two first high-frequency signals; first antenna means for simultaneously emitting linearly polarized waves that are orthogonal to each other from two excitation units according to the two first high-frequency signals divided by the first branch means, to generate a right-hand elliptically polarized wave; first phase adjustment means for adjusting a phase of at least one of the two first high-frequency signals to be input to the respective excitation units, and a second antenna apparatus comprising: second high-frequency output means for outputting a second high-frequency signal having the same frequency component as that of the first high-frequency signal; second branch means for dividing the second high-frequency signal output from the second high-frequency output means into two second high-frequency signals; second antenna means for simultaneously emitting linearly polarized waves that are orthogonal to each other from two excitation units according to the two second high-frequency signals divided by the second branch means, to generate a left-hand elliptically polarized wave; and second phase adjustment means for adjusting a phase of at least one of the two second high-frequency signals to be input to the respective excitation units.
(Supplementary Note 7) A method of adjusting an antenna apparatus comprising the steps of: outputting a first high-frequency signal; outputting a second high-frequency signal having the same frequency component as that of the first high-frequency signal; emitting a right-hand elliptically polarized wave according to the first high-frequency signal that is output; emitting a left-hand elliptically polarized wave according to the second high-frequency signal that is output; and adjusting a phase of at least one of the first high-frequency signal and the second high-frequency signal that are output.

This application claims the benefit of priority, and incorporates herein by reference in its entirety, the following Japanese Patent Application No. 2010-117305 filed on May 21, 2010.

### REFERENCE SIGNS LIST

1 ANTENNA APPARATUS

2 FIRST HIGH-FREQUENCY OUTPUT MEANS

3 SECOND HIGH-FREQUENCY OUTPUT MEANS

4 FIRST ANTENNA MEANS

5 SECOND ANTENNA MEANS

6 PHASE ADJUSTMENT MEANS

10 ANTENNA APPARATUS

11 FIRST HIGH-FREQUENCY SOURCE

12 FIRST PHASE ADJUSTMENT MECHANISM

13 FIRST ANTENNA

14 SECOND HIGH-FREQUENCY SOURCE

15 SECOND PHASE ADJUSTMENT MECHANISM

16 SECOND ANTENNA

17 POWER SUPPLY LINE

41 FIRST SWITCH

42 SECOND SWITCH

51 FIRST POWER AMPLIFIER

52 SECOND POWER AMPLIFIER

What is claimed is:

1. An antenna apparatus comprising:
a first high-frequency output portion for outputting a first high-frequency signal;
a second high-frequency output portion for outputting a second high-frequency signal having the same frequency component as that of the first high-frequency signal;
a first antenna for emitting a right-hand elliptically polarized wave according to the first high-frequency signal output from the first high-frequency output portion;
a second antenna for emitting a left-hand elliptically polarized wave according to the second high-frequency signal output from the second high-frequency output portion; and
a phase adjustment portion for adjusting a phase of at least one of the first high-frequency signal output from the first high-frequency output portion and the second high-frequency signal output from the second high-frequency output portion.

2. The antenna apparatus according to claim 1, wherein each of the first antenna and the second antenna is an array antenna including a plurality of antenna elements.

3. The antenna apparatus according to claim 1, further comprising a switch portion for switching at least one of a connection between the first high-frequency output portion and the first antenna and a connection between the second high-frequency output portion and the second antenna to a connection state and a non-connection state.

4. The Antenna apparatus according to claim 1, further comprising power adjustment means for adjusting a radiation output of at least one of the first antenna means and the second antenna means.

5. An antenna apparatus comprising:
a high-frequency output portion for outputting a high-frequency signal;
a branch portion for dividing the high-frequency signal output from the high-frequency output portion into two high-frequency signals having the same frequency component;
a first antenna for emitting a left-hand elliptically polarized wave according to one of the two high-frequency signals divided by the branch portion;
a second antenna for emitting a right-hand elliptically polarized wave according to the other one of the two high-frequency signals divided by the branch portion; and
a phase adjustment portion for adjusting a phase of at least one of the high-frequency signal input to the first antenna and the high-frequency signal input to the second antenna.

6. An antenna system comprising:
a first antenna apparatus comprising:
a first high-frequency output portion for outputting a first high-frequency signal;
a first branch portion for dividing the first high-frequency signal output from the first high-frequency output portion into two first high-frequency signals;
a first antenna for simultaneously emitting linearly polarized waves that are orthogonal to each other from two excitation units according to the two first high-frequency signals divided by the first branch portion, to generate a right-hand elliptically polarized wave;
a first phase adjustment portion for adjusting a phase of at least one of the two first high-frequency signals to be input to the respective excitation units, and
a second antenna apparatus comprising:
a second high-frequency output portion for outputting a second high-frequency signal having the same frequency component as that of the first high-frequency signal;
a second branch portion for dividing the second high-frequency signal output from the second high-frequency output portion into two second high-frequency signals;
a second antenna for simultaneously emitting linearly polarized waves that are orthogonal to each other from two excitation units according to the two second high-frequency signals divided by the second branch portion, to generate a left-hand elliptically polarized wave; and
a second phase adjustment portion for adjusting a phase of at least one of the two second high-frequency signals to be input to the respective excitation units.

7. A method of adjusting an antenna apparatus comprising:
outputting a first high-frequency signal;
outputting a second high-frequency signal having the same frequency component as that of the first high-frequency signal;
emitting a right-hand elliptically polarized wave according to the first high-frequency signal that is output;
emitting a left-hand elliptically polarized wave according to the second high-frequency signal that is output; and
adjusting a phase of at least one of the first high-frequency signal and the second high-frequency signal that are output.
